(19) United States
(12) Patent Application Publication
(10) Pub. No.: US 2003/0179499 A1
(43) Pub. Date: Sep. 25, 2003

(54) Magnetic head unit and method for fabricating the same

(76) Inventors: Yasuhiko Shinjo, Kanagawa (JP); Yoshihiko Uchida, Kanagawa (JP); Morio Kondo, Kanagawa (JP); Kiyohide Sakihama, Tokyo (JP)

Correspondence Address: WHITHAM, CURTIS & CHRISTOFFERSON, P.C., SUITE 340, 11491 SUNSET HILLS ROAD, P.O. Box 9204, RESTON, VA, 20190, US

(21) Appl. No.: 10/390,713

(22) Filed: Mar. 19, 2003

(30) Foreign Application Priority Data
Mar. 19, 2002 (JP) P2002-076011
Mar. 19, 2002 (JP) P2002-076012

(51) Int. Cl. G11B 5/10

(52) U.S. Cl. 360/129

(57) ABSTRACT

A magnetic head unit includes a head chip, a plurality of magnetic head elements, a pair of side chips and a base member. The head chip has a first face. The plurality of magnetic head elements are arranged on the first face of the head chip. The pair of side chips sandwich the head chip from both sides of the first face thereof. The base member holds the head chip and the side chips. The head chip, the side chips and the base members are joined to each other by conductive resin.

### BACKGROUND OF THE INVENTION

The present invention relates to a magnetic head unit and a method for fabricating the same and, in particular, relates to a magnetic head unit and a method for fabricating the same in which respective members thereof are joined by conductive resin.

As a magnetic head device for recording a signal on and reproducing a signal from a magnetic recording tape, a so-called multi-channel type magnetic head device is known in which a plurality of magnetic head elements as shown in FIGS. 4A and 4B are arranged. Such a related magnetic head device 50 is configured in a manner that magnetic head assemblies 100 shown in FIG. 4B are joined to each other by adhesive resin.

The magnetic head unit 100 is configured in a manner that the magnetic gaps 102a of a plurality of magnetic head elements 102 are arranged in parallel so as to face on a sliding face 101 on which a magnetic recording tape is slid, whereby the plurality of magnetic gaps 102a record a signal on and reproduce a signal from the magnetic recording tape. The magnetic head unit 100 is formed by a head chip 103 having a plurality of the magnetic head elements 102, a protection chip 104 disposed so as to oppose to the one side face of the head chip 103, a pair of side chips 105 disposed so as to sandwich the head chip 103 and the protection chip 104 therebetween, a base member 106 on which the head chip 103 and the side chips 105 are attached, and a flexible printed wiring board 107 coupled to the terminal portions 102b of the magnetic head elements 102.

Each of the head chip 103, the protection chip 104, the side chips 105 and the base member 106 is formed by ceramics material such as alumina-titanium carbide (Al203-TiC), for example.

The head chip 103, the side chips 105 and the base member 106 are joined from one another by adhesive resin in a manner that the side face 103a of the head chip 103 is abutted against the side face 105a of the side chip, the side face 103b of the head chip 103 is abutted against the side face 105b of the side chip, and the lower face 13a of the head chip 103 and the lower faces 105c of the side chips 105 are abutted against the upper face 106a of the base member 106.

Next, the pair of the magnetic head assemblies 100 thus configured are joined to each other by adhesive resin in a manner that joining faces 51 each formed by the head chip 103, the side chips 105 and the base member 106 are abutted to each other. Then, the magnetic head device 50 is completed by forming a center groove 52 and a pair of side grooves 53 through the processing of the sliding face.

However, the related magnetic head device 50 is configured by the magnetic head assemblies 100 each formed by many parts and the adhesive resin is used at the time of joining the head chip 103, the side chips 105 and the base member 106 constituting the magnetic head unit 100, so that the portions among the respective members, that is, the head chip 103, the side chips 105 and the base member 106 are insulated. Thus, the magnetic head device 50 has a problem that the magnetic head elements 102 may be broken due to static electricity generated at the time of processing the sliding face. In order to eliminate such a problem, it is required to separately provide an earth structure for earthing or grounding static electricity generated among the head chip 103, the side chips 105 and the base member 106. However, in the fabricating process of the magnetic head device, this process of providing the earth structure becomes a reason for degrading the fabricating efficiency since this process is complicated.

Also, in the related magnetic head device 50, the base member 106 as well as the head chip 103 having the sliding face on which a magnetic recording tape slides, the protection chip 104 and the side chips 105 are formed by high-hardness ceramics material, so that there arises a problem that the magnetic head device is expansive and degraded in processing efficiency or properties thereof.

### SUMMARY OF THE INVENTION

It is therefore an object of the present invention to provide a magnetic head device and a method for fabricating the same which can eliminate the earth structure for earthing or grounding static electricity which is generated at the main body of the magnetic head device and becomes a cause of a problem.

Also, it is therefore an object of the present invention to provide a magnetic head device and a method for fabricating the same which can improve the processing efficiency or properties of the magnetic head device and reduce the manufacturing cost thereof.

In order to achieve the above object, according to the present invention, there is provided a magnetic head unit comprising:

a head chip, having a first face which is provided with a plurality of magnetic gaps;

a pair of side chips, which sandwich the head chip from both sides of the first face thereof; and

a base member, which holds the head chip and the side chips,

wherein the head chip, the side chips and the base members are joined to each other by conductive resin.

Thus, the magnetic head unit is kept to hold static-electricity resistance properties even if an earth line for grounding static electricity which is generated at the magnetic unit main body and becomes a cause of a problem is eliminated. Further, the working efficiency for manufacturing the magnetic head unit can be improved and the manufacturing cost of the magnetic head device can be reduced.

According to the present invention, there is also provided a method for fabricating a magnetic head unit, comprising the steps of:

providing a head chip which has a first face provided with a plurality of magnetic gaps;

providing a pair of side chips;

providing a base member;

sandwiching the head chip from both sides of the first face thereof by the pair of side chips;

holding the head chip and the side chips on the base member; and

joining the head chip, the side chips and the base member to each other by conductive resin to form the magnetic head unit.

Preferably, the method further comprising the step of joining at least two head unit formed in the joining step to each other by the conducive resin.

In the above method, the magnetic head unit is kept to hold static-electricity resistance properties even if an earth line for grounding static electricity which is generated at the magnetic head main body and becomes a cause of a problem is eliminated. Further, the working efficiency for manufacturing the magnetic head unit can be improved and the manufacturing cost of the magnetic head unit can be reduced.

Preferably, the base member is formed by material with Vickers hardness equal to or less than 1500.

In the above method, processing efficiency or properties of the magnetic head unit can be improved and the manufacturing cost thereof can be reduced. Further, the magnetic head unit itself can be light-weighted.

Preferably, the base member is formed by resin material.

In the above method, processing efficiency or properties of the magnetic head unit can be improved and the manufacturing cost thereof can be reduced. Further, the magnetic head unit itself can be light-weighted.

According to the present invention, there is also provided a magnetic head unit comprising:

a head chip, having a first face which is provided with a plurality of magnetic gaps;

a pair of side chips, which sandwich the head chip from both sides of the first face thereof; and

a base member, which holds the head chip and the side chips,

wherein the base member is formed by material with Vickers hardness equal to or less than 1500.

Preferably, the base member is formed by low-hardness ceramics.

Preferably, the low-hardness ceramics is CaTiO3 or BaTiO.

Preferably, the base member is formed by ferrite.

In the above configurations, processing efficiency or properties of the magnetic head unit can be improved and the manufacturing cost thereof can be reduced. Further, the magnetic head unit itself can be light-weighted.

Preferably, the base member is formed by resin material.

Preferably, the head chip, the side chips and the base member are joined to each other by conductive resin.

In the above configurations, processing efficiency or properties of the magnetic head unit can be improved and the manufacturing cost thereof can be reduced. Further, the magnetic head unit itself can be light-weighted. In this case, preferably, the head chip, the side chips and the pedestal are joined from one another by conductive resin. Thus, static electricity generated at the magnetic head unit can be grounded efficiently.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view showing the configuration of the magnetic head unit of a magnetic head device according to an embodiment of the invention;

FIG. 2 is a perspective view showing the external appearance of the magnetic head unit of the magnetic head device according to the embodiment of the invention;

FIG. 3 is a perspective view showing the external appearance of the magnetic head device according to the embodiment of the invention;

FIG. 4A is a perspective view showing the external appearance of a related magnetic head device; and

FIG. 4B is a perspective view showing the external appearance of a related magnetic head unit.

### DETAILED DESCRIPTION OF THE PREFERRED EMBODIMENTS

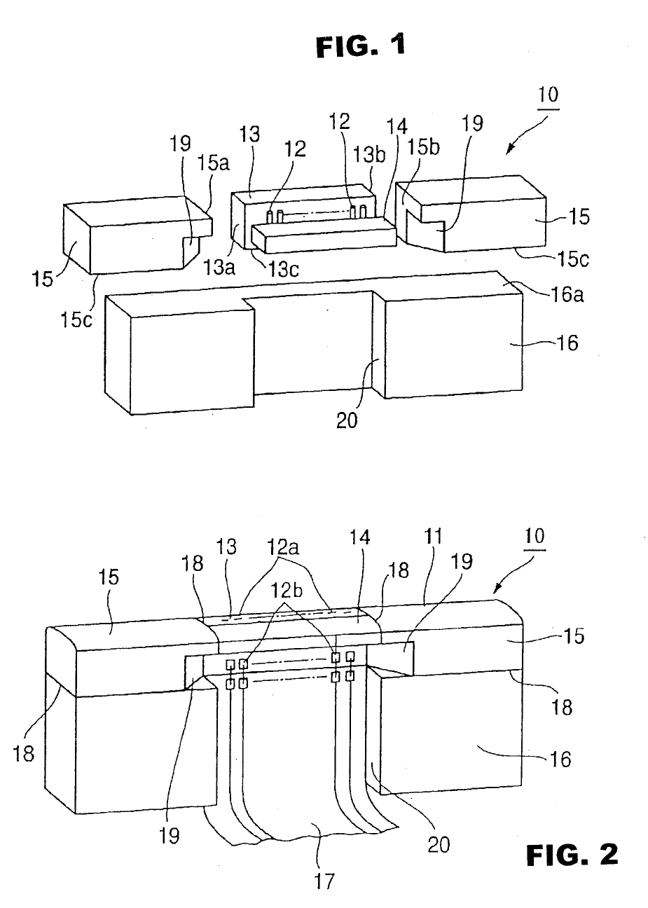

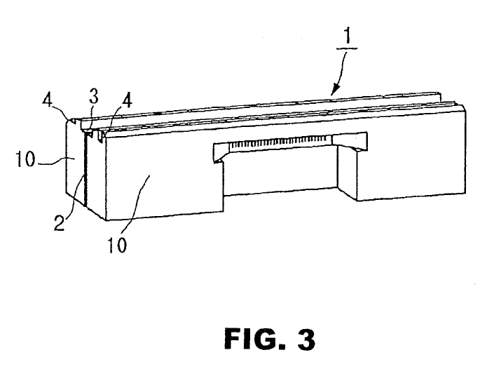

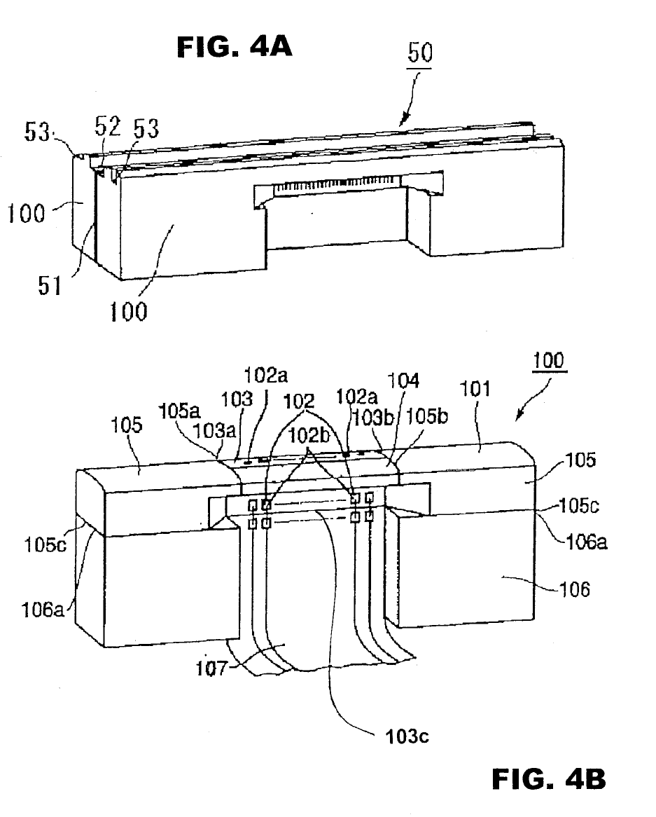

An embodiment of the invention will be explained in detail with reference to FIGS. 1 to 3. FIG. 1 shows the configuration of the magnetic head unit of the magnetic head device according to the invention, FIG. 2 shows the external appearance of the magnetic head unit, and FIG. 3 shows the entire appearance of the magnetic head device according to the invention. As shown in FIGS. 1 and 2, the magnetic head unit 10 of the magnetic head device 1 shown as an embodiment of the invention is configured in a manner that the magnetic gaps 12a of a plurality of magnetic head elements 12 are arranged in parallel so as to face on a sliding face 11 on which a magnetic recording tape slides, whereby the plurality of magnetic head elements 12 record a signal in and reproduce a signal from the magnetic recording tape. The magnetic head unit 10 is formed by a head chip 13 having a plurality of the magnetic head elements 12, a protection chip 14 disposed so as to oppose to the one side face of the head chip 13, a pair of side chips 105 disposed so as to sandwich the head chip 13 and the protection chip 14 therebetween, a base member 16 on which the head chip 13 and the side chips 15 are attached, and a flexible printed wiring board 17 coupled to the terminal portions 12b of the magnetic head elements 12.

The head chip 13, the side chips 15 and the base member 16 are joined from one another by conductive resin 18 in a manner that the side face 13a of the head chip 13 is abutted against the side face 15a of the side chip, the side face 13b of the head chip 13 is abutted against the side face 15b of the side chip, and the lower face 13c of the head chip 13 and the lower faces 15c of the side chips 15 are abutted against the upper face 16a of the base member 16. The conductive resin 18 is high molecular or high polymer material with a high dielectric constant. For example, polythiazyl etc. may be employed as the conductive resin of inorganic polymer and halide polyacetylene etc. may be employed as the conductive resin of organic polymer.

In the magnetic head device 1, each of the magnetic head elements 12 is formed on a ceramic board and provided with a reproducing portion which is formed by a not-shown magnetoresistive element etc. and an electromagnetic induction type recording portion formed by the method such as the sputtering method, the photo-etching method etc. The head chip 13 is provided with the magnetic head elements 12 which are formed by ceramic material such as alumina-titanium carbide (Al203-TiC) and disposed in parallel on the one faced side of the head chip.

The protection chip 14 is formed by ceramic material such as alumina-titanium carbide (Al203-TiC) and configured in a shape sufficient for covering an area of the head chip 13 except for the terminal portions 12b of the magnetic head elements 12.

The side chips 15 constituting the sliding face 11 on which the magnetic recording tape slides are formed by ceramic material such as alumina-titanium carbide (Al203-TiC) like the head chip. The pair of the side chips 15 are provided with notched portions 19 on their faces sandwiching the head chip 13 therebetween. Each of the notched portions 19 is formed on the face of the side chip which abuts against the base member 16 so as to leave the main face of the side chip which serves as a sliding face of the side chip 15. In other words, the pair of the side chips 15 are provided with the notched portions 19 at their portions sandwiching the terminal portions 12b of the magnetic head elements 12 therebetween.

The base member 16 is formed by material with Vickers hardness equal to or less than 1500, that is, low-hardness ceramics such as CaTiO3 or BaTiO which is excellent in processing efficiency or properties and is cheap as compared with Al203-TiC, for example. The base member 16 is provided with a concave groove 20 having a width corresponding to the width of the flexible printed wiring board. Thus, the flexible printed wiring board 17 can be positioned accurately within the concave groove 20 of the base member 16. Alternatively, the base member 16 may be formed by ferrite or resin material. When the base member is formed by resin material, since the portions among the head chip 13, the side chips 15 and the base member 16 are insulated, the head characteristics may be degraded due to static electricity. Thus, in this case, it is preferable to join the head chip 13, the side chips 15 and the base member 16 by conductive resin.

The magnetic head device 1 is formed in the following manner. That is, the head chip 13, the protection chip 14, the side chips 15 and the base member 16 are combined and joined from one another by means of the conductive resin 18 as described above thereby to form the magnetic head unit 10. Then, a pair of the magnetic head assemblies 10 are abutted to each other at their joining faces 2 each constituted by the head chip 13, the protection chip 14, the side chips 15 and the base member 16 and then joined to each other by means of the conductive resin 18. Then, the sliding face 11 is processed in a cylindrical shape, and a center groove 3 and a pair of side grooves 4 are formed by processing the sliding face. Thereafter, the flexible printed wiring board 17 is attached to the magnetic head assemblies. In this case, since the flexible printed wiring board 17 is disposed along the concave groove 20 formed at the base member 16, the flexible printed wiring board can be positioned quite accurately. Then, the flexible printed wiring board 17 and the terminal portions 12b of the magnetic head elements 12 are coupled by the wire bonding in a state that the flexible printed wiring board 17 is positioned.

As described above, since the low-hardness material which can be scraped easily is used as the material of the base member 16, the processing efficiency or properties of the magnetic head device can be improved and the manufacturing cost thereof can be reduced. Further, the magnetic head device itself can be light-weighted.

Also, the magnetic head device 1 is kept to hold static-electricity resistance properties even if the earth structure for eliminating static electricity which degrades the head characteristics is not provided. Further, the working efficiency for manufacturing the magnetic head device 1 can be improved and the manufacturing cost of the magnetic head device can be reduced.

The invention is not limited to the embodiment and, of course, various modification may be made within a range not departing from the gist of the invention.

What is claimed is:

1. A magnetic head unit comprising:
a head chip, having a first face which is provided with a plurality of magnetic gaps;
a pair of side chips, which sandwich the head chip from both sides of the first face thereof; and
a base member, which holds the head chip and the side chips,
wherein the head chip, the side chips and the base members are joined to each other by conductive resin.

2. A method for fabricating a magnetic head unit, comprising the steps of:
providing a head chip which has a first face provided with a plurality of magnetic gaps;
providing a pair of side chips;
providing a base member;
sandwiching the head chip from both sides of the first face thereof by the pair of side chips;
holding the head chip and the side chips on the base member; and
joining the head chip, the side chips and the base member to each other by conductive resin to form the magnetic head unit.

3. The method as set forth in claim 2, further comprising the step of joining at least two head unit formed in the joining step to each other by the conducive resin.

4. The method as set forth in claim 2, wherein the base member is formed by material with Vickers hardness equal to or less than 1500.

5. The method as set forth in claim 2, the base member is formed by resin material.

6. A magnetic head unit comprising:
a head chip, having a first face which is provided with a plurality of magnetic gaps;
a plurality of magnetic head elements, arranged on the first face of the head chip;
a pair of side chips, which sandwich the head chip from both sides of the first face thereof; and
a base member, which holds the head chip and the side chips,
wherein the base member is formed by material with Vickers hardness equal to or less than 1500.

7. The magnetic head unit as set forth in claim 6, wherein the base member is formed by low-hardness ceramics.

8. The magnetic head unit as set forth in claim 7, wherein the low-hardness ceramics is CaTiO3 or BaTiO.

9. The magnetic head unit as set forth in claim 6, wherein the base member is formed by ferrite.

10. The magnetic head unit as set forth in claim 6, wherein the base member is formed by resin material.

11. The magnetic head unit as set forth in claim 6, wherein the head chip, the side chips and the base member are joined to each other by conductive resin.
